(19) United States
(12) Patent Application Publication
(10) Pub. No.: US 2019/0333076 A1
(43) Pub. Date: Oct. 31, 2019

(54) CUSTOMER BEHAVIOR ANALYSIS METHOD, CUSTOMER BEHAVIOR ANAYLSIS SYSTEM, AND STORAGE MEDIUM

(71) Applicant: HONGFUJIN PRECISION ELECTRONICS (TIANJIN) CO.,LTD., Tianjin (CN)

(72) Inventors: PO-CHENG CHEN, New Taipei (TW); YU-WEN CHEN, New Taipei (TW); KAI-FAN LEE, New Taipei (TW)

(21) Appl. No.: 16/006,985

(22) Filed: Jun. 13, 2018

(30) Foreign Application Priority Data
Apr. 25, 2018 (CN) 201810381492.1

(51) Int. Cl. G06Q 30/02; G06K 9/00

(52) U.S. Cl. CPC G06Q 30/0201; G06K 9/00288; G06K 9/00255

(57) ABSTRACT

A method for applying a customer behavior analysis system and a storage medium containing computer instructions for the purpose includes obtaining images of a scene in a store or other commercial concern, detecting living faces from the images and rejecting the heads and faces on posters and the heads and faces of store dummies. Of the remaining faces deemed to be of real customers, applying predetermined rules to determine if a customer is a new customer or a repeat customer. The face of a new customer can be added to a tracing list, and all customers can be traced and their behavior in respect of sales sections visited and particular merchandise examined can be analyzed based on further predetermined rules.

### FIELD

The subject matter herein generally relates to customer behavior systems.

### BACKGROUND

Retailers can adopt computer-based customer behavior analysis system (CBAS) as technology, such as face detection, age estimation, gender classification, mood estimation, is rapidly evolving. For retailers, a CBAS facilitates a better understanding of consumer behavior, according to the analysis, the retailer can improve their marketing decisions. However, there is room for improvement for current CBAS.

### BRIEF DESCRIPTION OF THE DRAWINGS

Implementations of the present disclosure will now be described, by way of example only, with reference to the attached figures.

FIG. 1 is a diagram of an embodiment of a customer behavior analysis system.

FIG. 2 is a diagram of an embodiment of a method for customer behavior analysis.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series, and the like.

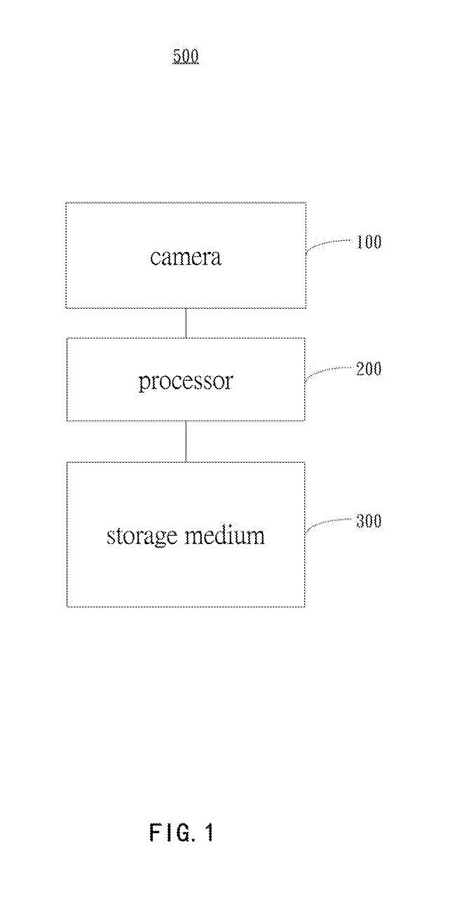

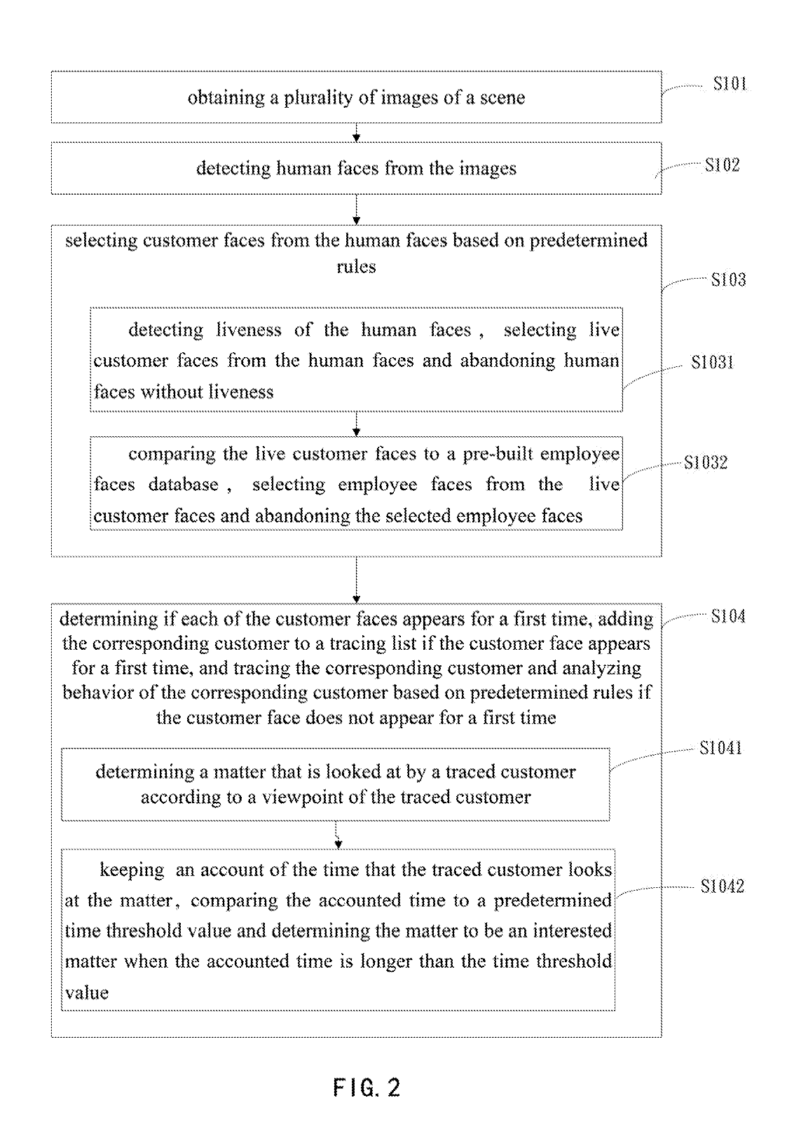

FIGS. 1 to 2 illustrate a customer behavior analysis system 500 and a method for applying the customer behavior analysis system 500.

The customer behavior analysis system 500 includes a camera 100, a processor 200, and a storage medium 300.

The storage medium 300 stores at least one software program in the form of computerized codes that can be executed by the processor 200. The at least one software program includes instructions for implementing the customer behavior analysis method.

The customer behavior analysis method can include following steps.

S101. Obtaining images of a scene by the camera 100. For example, the scene can be an area that used to present commodity information to customers, such as a goods shelf, a storage rack, or an advertising display area.

S102. Detecting human faces from the images.

S103. Selecting customer faces from the human faces based on predetermined rules.

S104. Determining if any of the customer faces appears for a first time, and adding such first time customer to a tracing list. Analyzing behavior of repeat customer based on predetermined rules if the customer face is appearing for a second or greater number of times.

For example, selecting customer faces from the human faces based on predetermined rules can further include the following sub-steps.

S1031. Detecting living human faces as opposed to inanimate human faces, selecting such live faces from the human faces and ignoring inanimate human faces.

For example, in a scene, there could be dummy models beside displayed merchandises. By detecting live human faces, the customer behavior analysis system 500 can distinguish between a dummy model with a head and face from a real human head and face. Similarly, the customer behavior analysis system 500 can distinguish and ignore faces on a poster, or on a commercial video, from the live human faces of real people.

Selecting customer faces from live human faces based on predetermined rules can further include the following sub-steps.

S1032. Comparing the customer faces to a pre-stored database of faces of employees of the establishment, and selecting and ignoring employee faces.

By comparing the human faces in the images to employee faces, the customer behavior analysis system 500 can distinguish between faces of employees and faces of customers.

Tracing a customer and analyzing behavior of the customer based on predetermined rules can include the following sub-steps.

S1041. Determining a department or merchandise type (“matter”) that is looked at by a traced customer.

S1042. Accounting for the time that the traced customer is looking at the matter, comparing the counted time to a predetermined time period and determining that the traced customer is interested in a matter when the counted time is longer than the predetermined time period.

Before adding the corresponding customer to a tracing list, the at least one software program can further comprise instructions for the following steps.

Estimating the age of the customer.

Assessing the gender of the customer.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A customer behavior analysis method comprising:
obtaining a plurality of images of a scene;
detecting human faces that may be contained in the images;
selecting customer faces from the detected human faces based on predetermined rules;
determining if each of the customer faces appears for a first time, adding the corresponding first time customer to a tracing list, and, if the customer face does not appear for a first time, tracing the corresponding customer and analyzing behavior of the corresponding customer based on predetermined rules.

2. The customer behavior analysis method of claim 1, wherein selecting customer faces from the human faces based on predetermined rules comprises:
detecting live human faces from the human faces in the image;
selecting live customer faces from the human faces and ignoring ignoringnon-live human faces.

3. The customer behavior analysis method of claim 2, wherein selecting customer faces from the human faces based on predetermined rules further comprises:
comparing the live customer faces to an employee faces database; and
selecting employee faces from the live customer faces and ignoring the selected employee faces.

4. The customer behavior analysis method of claim 1, wherein tracing the corresponding customer and analyzing behavior of the corresponding customer based on predetermined rules comprises:
determining a matter that is looked at by a traced customer according to a viewpoint of the traced customer;
accounting for the time that the traced customer looks at the matter;
comparing the accounted time to a predetermined time threshold value; and
determining the matter to be an interested matter when the accounted time is longer than the time threshold value.

5. The customer behavior analysis method of claim 1, wherein before adding the corresponding customer to a tracing list, the customer behavior analysis method further comprises:
estimating the age of the corresponding customer.

6. The customer behavior analysis method of claim 1, wherein before adding the corresponding customer to a tracing list, the customer behavior analysis method further comprises:
estimating the gender of the corresponding customer.

7. A customer behavior analysis system comprising:
a camera;
a processor; and
a storage medium storing at least one software programs in the form of computerized codes that are executed by the processor, the at least one software programs comprising instructions for:
obtaining a plurality of images of a scene by the camera;
detecting human faces from the images;
selecting customer faces from the human faces based on predetermined rules;
determining if each of the customer faces appears for a first time, adding the corresponding first time customer to a tracing list, and if the customer face does not appear for a first time, tracing the corresponding customer and analyzing behavior of the corresponding customer based on predetermined rules.

8. The customer behavior analysis system of claim 7, wherein selecting customer faces from the human faces based on predetermined rules comprises:
detecting live human faces from the human faces in the image;
selecting live customer faces from the human faces and ignoring non-live human faces.

9. The customer behavior analysis system of claim 8, wherein selecting customer faces from the human faces based on predetermined rules further comprises:
comparing the live customer faces to an employee faces database; and
selecting employee faces from the live customer faces and ignoring the selected employee faces.

10. The customer behavior analysis system of claim 7, wherein tracing the corresponding customer and analyzing behavior of the corresponding customer based on predetermined rules comprises:
determining a matter that is looked at by a traced customer according to a viewpoint of the traced customer;
accounting for the time that the traced customer looks at the matter;
comparing the accounted time to a predetermined time threshold value; and
determining the matter to be an interested matter when the accounted time is longer than the time threshold value.

11. The customer behavior analysis system of claim 7, wherein before adding the corresponding customer to a tracing list, the at least one software programs further comprises instructions for:
estimating the age of the corresponding customer.

12. The customer behavior analysis system of claim 7, wherein before adding the corresponding customer to a tracing list, the at least one software programs further comprises instructions for:
estimating the gender of the corresponding customer.

13. A storage medium comprising at least one software programs in the form of computerized codes that are executed by a processor, the at least one software programs comprising instructions for:
obtaining a plurality of images of a scene;
detecting human faces from the images;
selecting customer faces from the human faces based on predetermined rules;
determining if each of the customer faces appears for a first time, adding the corresponding customer to a tracing list if the customer face appears for a first time, and tracing the corresponding customer and analyzing behavior of the corresponding customer based on predetermined rules if the customer face does not appear for a first time.

14. The storage medium of claim 13, wherein selecting customer faces from the human faces based on predetermined rules comprises:
detecting liveness of the human faces;
selecting live customer faces from the human faces and ignoring human faces without liveness.

15. The storage medium of claim 14, wherein selecting customer faces from the human faces based on predetermined rules further comprises:
comparing the live customer faces to an employee faces database; and
selecting employee faces from the live customer faces and ignoring the selected employee faces.

16. The storage medium of claim 13, wherein tracing the corresponding customer and analyzing behavior of the corresponding customer based on predetermined rules comprises:
determining a matter that is looked at by a traced customer according to a viewpoint of the traced customer;
accounting for the time that the traced customer looks at the matter;
comparing the accounted time to a predetermined time threshold value; and
determining the matter to be an interested matter when the accounted time is longer than the time threshold value.

17. The storage medium of claim 13, wherein before adding the corresponding customer to a tracing list, the at least one software programs further comprises instructions for:
estimating the age of the corresponding customer.

18. The storage medium of claim 13, wherein before adding the corresponding customer to a tracing list, the at least one software programs further comprises instructions for:
estimating the gender of the corresponding customer.
